(19) United States
(12) Patent Application Publication
(10) Pub. No.: US 2019/0339187 A1
(43) Pub. Date: Nov. 7, 2019

(54) METHODS AND SYSTEMS TO DETERMINE A CONCENTRATION OF SEALING PARTICULATES IN DRILLING FLUID

(71) Applicant: Sharp-Rock Technologies, Inc., Cypress, TX (US)

(72) Inventor: Hong Max Wang, Cypress, TX (US)

(21) Appl. No.: 16/373,742

(22) Filed: Apr. 3, 2019

Related U.S. Application Data
(60) Provisional application No. 62/665,568, filed on May 2, 2018.

(51) Int. Cl. G01N 15/06; E21B 33/138

(52) U.S. Cl. CPC G01N 15/0618; G01N 2015/0662; E21B 33/138

(57) ABSTRACT

Examples of the present disclosure relate to systems and methods determining the minimum concentration of sealing particles to position within a drilling fluid to prevent losing drilling fluid into a hydraulic fracture.

### BACKGROUND INFORMATION

### Field of the Disclosure

Examples of the present disclosure relate to systems and methods for determining a concentration of a particulate sealing composition for a drilling fluid to prevent losing drilling fluid into a hydraulic fracture. More specifically, embodiments relate to utilizing a relationship between a concentration of a sealing composition and a spurt loss to determine a minimum concentration of the sealing particulates to be embedded within drilling fluid.

### Background

When drilling a wellbore for hydrocarbons, drilling fluid of a certain density is typically pumped downhole to help cut rock, clean cuttings, lubricate a drill bit, cool the drill bit, etc. While being pumped downhole, the drilling fluid may apply hydraulic pressure against the wellbore wall, which can rupture a weak zone of the wellbore and induce a hydraulic fracture. This drilling fluid may continue to flow into the hydraulic fracture and get lost. Conventionally to reduce losses for drilling fluid, before the weak zone is drilled, sealing particles are mixed into the drilling fluid to turn the drilling fluid into a sealing fluid. In this way, when the wellbore is ruptured and drilling fluid starts to flow into the fracture, the drilling fluid in the sealing fluid then may carry the sealing particles to the fracture along with the flow. At the early stage of the hydraulic fracture, hopefully the fracture width is typically small and majority of the sealing particles may not be able to get into the fracture with the flow. When enough of the sealing particles that cannot enter the fracture accumulate at the entrance of the fracture, the hydraulic fracture may be then sealed and no further drilling fluid may be lost into the fracture.

Any composition of sealing particles can only efficiently seal up to a certain fracture width or the sealing width, which may be close to the maximum size of the particles in the sealing composition. However, if the drilling fluid does not include a sufficient concentration of the sealing particles, a seal at the hydraulic fracture cannot be formed when the growing fracture width opens to the sealing width. This leads to further widening of the hydraulic fracture beyond the sealing width. Alternatively, utilizing a too high concentration of the sealing particles may limit the effectiveness of the drilling fluid and is not cost effective either.

Accordingly, needs exist for systems and methods to efficiently and effectively determine the minimum concentration of sealing particles within a drilling fluid to prevent losing drilling fluid when drilling a specific weak wellbore.

### SUMMARY

Examples of the present disclosure relate to systems and methods determining the minimum concentration of sealing particulates mixed within a drilling fluid to prevent losing drilling fluid while sealing a hydraulic fracture. Embodiments described herein utilize determining a certain weight of a particulate sealing composition required to seal a unit section of a hydraulic fracture at a wellbore wall based on a concentration of the sealing particulates within the drilling fluid and the unit spurt loss from a slot disk test with a slot simulating the entrance of a unit section of the hydraulic fracture. This weight may be approximated by collecting and weighing all the particulates of a seal from a slot disk test. Apparently, the less the weight, the more efficient the sealing.

In embodiments, sealing particulates may be mixed with drilling fluid at a first concentration to form a sealing fluid. Next, a spurt loss test may be performed by allowing the sealing fluid with the sealing particulates to flow through a slot within a disk. The weight required to seal the slot may be characterized as a unit sealing slot quantity constant based on the concentration of the sealing particulates and the unit spurt loss of the slot disk test.

In embodiments, where there are multiple sealing compositions it is possible to compare their relative sealing performance based on the unit sealing slot quantity constant of each of the sealing compositions. For example, if a first and second sealing composition of sealing particulates has the same sealing width but the first sealing composition has a smaller unit sealing slot quantity constant, then the first sealing composition may be more efficient than the second sealing composition. As such, the first sealing composition may be used with drilling fluid in a lower concentration than the second sealing concentration for the same weak wellbore.

In further embodiments, it may be required to determine the maximum unit spurt loss allowed into a fracture before the fracture opens to the sealing width of the sealing composition. If more spurt loss enters the fracture, the fracture may continue to widen further to a size that is beyond the sealing width, and no seal may be formed. Therefore, it may be required to determine the unit hydraulic fracture volume to hold the maximum unit spurt loss for the fracture at a unit section of the fracture. Different weak wellbores of different formation rock properties or drilling parameters may define different unit hydraulic fracture volumes.

Sealing particulates may be configured to have various sealing performances. Since sealing compositions may be comprised of various sealing particulates of different densities and sealing efficiencies, sealing fluids comprised of different sealing compositions may generate different slot sealing weights of the sealing particulates. However, for the same sealing composition, sealing a given slot would require only a certain weight of the sealing particulates. Therefore, when utilizing the same sealing composition, the weight of the sealing particulates required to form the seal to a unit length of the slot is constant. This weight is the unit sealing slot quantity constant.

In further embodiments, it may be required to determine the unit sealing slot quantity constant of a sealing composition of sealing particulates. For example, with a slot disk with a slot having a one foot length and 850 micron width and a sealing composition characterized with a sealing width of 850 microns based on the size of the sealing particulates, if a concentration of the sealing composition as 20 pounds per barrel of sealing fluid in drill fluid produces a spurt loss of 92 millimeters with the slot disk test, the unit sealing slot quantity constant is 5.24 grams per foot of slot length. For a different sealing composition, if a disk of multiple slots has a total slot length of 2 feet and each slot is 850 microns wide and the same spurt loss of 92 millimeters is produced, in another embodiment, then the unit sealing slot quantity constant for this sealing composition may be determined by multiplying the concentration of sealing particles per barrel by the spurt loss, and dividing that number by the total length of the slots. This may result in the unit sealing slot quantity constant for the sealing composition to be 2.62 grams per foot. Apparently, the latter sealing composition with a smaller unit sealing slot quantity constant is more efficient. A slot disk may have multiple slots of the same width W to have a total slot length L large enough in order to acquire enough accuracy of the spurt loss test.

In embodiments, the minimum concentration of the sealing composition may be based on the unit sealing slot quantity constant of the sealing composition, and the unit hydraulic fracture volume of a weak wellbore. The minimum concentration of the sealing composition in the drilling fluid may be determined by dividing the unit sealing slot quantity constant for the sealing composition by the unit hydraulic fracture volume for the weak wellbore.

In a first example, if it is determined that the unit hydraulic fracture volume is 40 milliliter per foot with the unit sealing slot quantity constant being 2.62 grams per foot, then it may be determined that the minimum concentration of the sealing composition in the drilling fluid is 23 pounds per barrel.

However, in a second example with a unit hydraulic fracture volume of 60 milliliter per foot, it may have a minimum concentration of the same sealing composition in the drilling fluid as 15.3 pounds per barrel.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a three dimension illustration of a 1 foot section of a part of a geological formation and wellbore, within which there is a section of a hydraulic fracture, according to an embodiment.

FIG. 2 depicts a slot disk, according to an embodiment.

FIG. 3 depicts a seal of particulate fracture sealing composition sealing a slot within a slot disk, according to an embodiment.

FIG. 4 depicts determining a unit sealing slot quantity constant based on the concentration of sealing particulates within a drilling fluid and the unit spurt loss volume of a slot disk test, according to an embodiment.

FIG. 5 depicts a method for determining the minimum concentration of a sealing composition of sealing particulates within drilling fluid to seal a hydraulic fracture for drilling a wellbore with the created sealing fluid, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art, that the specific detail need not be employed to practice the present embodiments. In other instances, well-known materials or methods have not been described in detail in order to avoid obscuring the present embodiments.

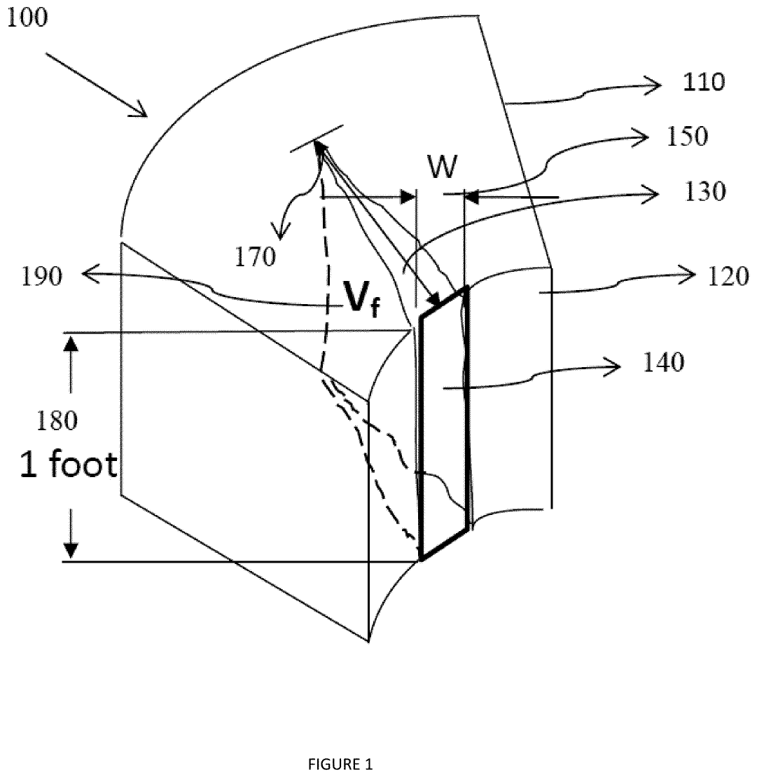

FIG. 1 depicts a three dimension illustration 100 of a unit (1 foot) section of a hydraulic fracture 130 within a geological formation 110 and wellbore 120, according to an embodiment. As shown in FIG. 1, hydraulic fracture 130 may have an entrance 140 that is exposed within the wellbore 120. The entrance 140 of the hydraulic fracture 130 may have a width 150 as W and a section height 180 as 1 foot. The fracture 130 may have a length 170 extending away from the wellbore 120 into formation 110. The width 150 and length 170 of hydraulic fracture 130 may be utilized to determine the unit fracture volume Vf 190 of the hydraulic fracture, or the unit hydraulic fracture volume. Methods for determining the volume of a unit section of the hydraulic fracture 130 are known, such as by U.S. Pat. No. 9,109,992, which is hereby incorporated by reference in its entirety.

In embodiments, responsive to a hydraulic fracture 130 being created, the width 150 and length 170 of the hydraulic fracture 130 may continue to grow unless hydraulic fracture 130 is sealed. Adding sealing particulates into drilling fluid at a high enough concentration may turn the drilling fluid into a sealing fluid that is utilized to seal hydraulic fracture 130, stopping hydraulic fracture 130 from increasing in size. Embodiments described herein determine a minimum concentration of the sealing particulates within a drilling fluid required to seal a hydraulic fracture 130 to prevent losing drilling fluid when drilling a weak wellbore.

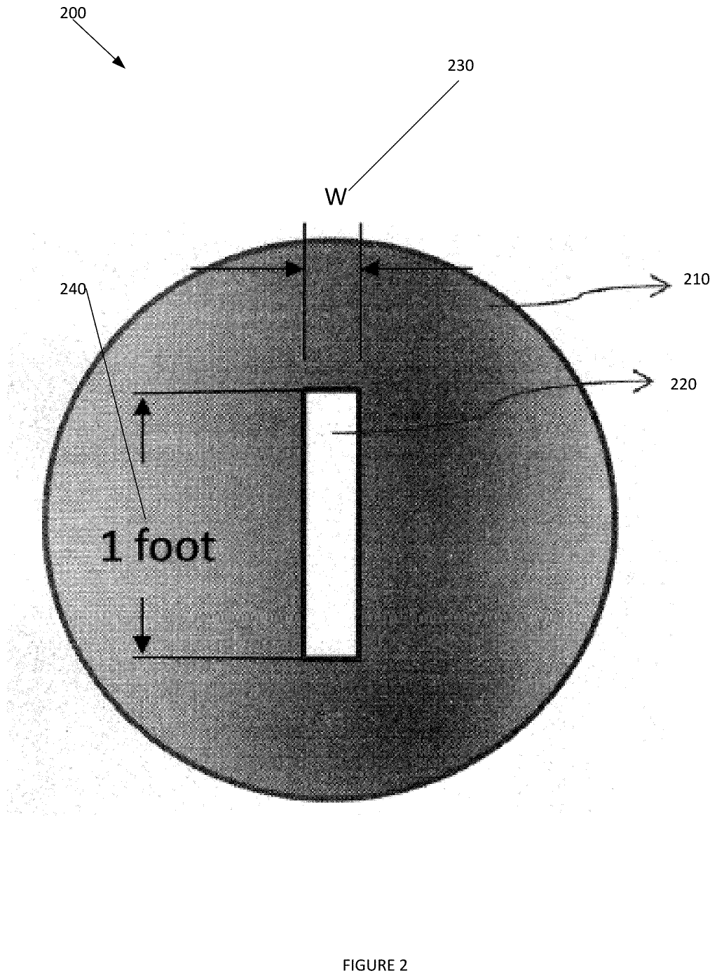

FIG. 2 depicts a slot disk 200, according to an embodiment. Slot disk 200 may be utilized to create a slot disk test to determine a unit spurt loss of a fracture sealing fluid. In embodiments, slot disk 200 may have a surface 210 with a slot 220, wherein slot 220 may have a width 230 as W and length 240. In embodiments, the length 240 may be 1 foot or of other lengths. The slot 220 within slot disk 200 may be configured to simulate a section of an entrance 140 of a hydraulic fracture within a wellbore. In embodiments, slot disk 200 may include a plurality of slots 220, which may each have different lengths. The unit spurt loss may be obtained from a spurt loss volume from a slot disk test converted to one over a unit length of the total slot length. The unit length is typically 1 foot long.

In embodiments, drilling fluid refers to any fluid that can suspend the sealing particulates for a slot disk test.

Systems and methods for determining a spurt loss of a fracture sealing fluid utilizing a slot disk 200 are well known. It may be typically called a slot disk test.

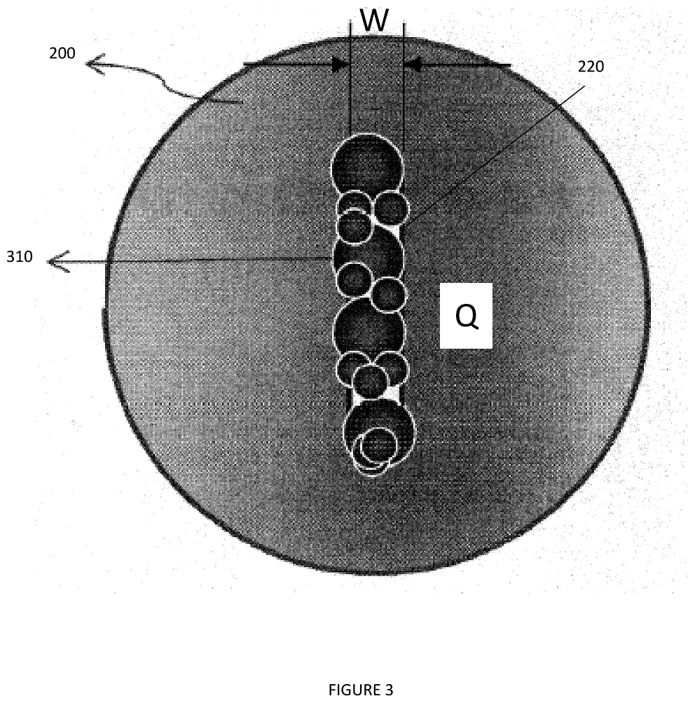

FIG. 3 depicts a seal 310 formed by a particulate fracture sealing composition on a slot 220 within a slot disk 200, according to an embodiment. In embodiments, a weight of the seal 310 or the weight of the sealing composition in drilling fluid required just to seal a slot 220 may be determined based on the spurt loss volume of the slot disk test and the concentration of the particulate fracture sealing composition within a sealing fluid for the slot disk test, wherein the sealing fluid is comprised of the particulate fracture sealing composition and drilling fluid.

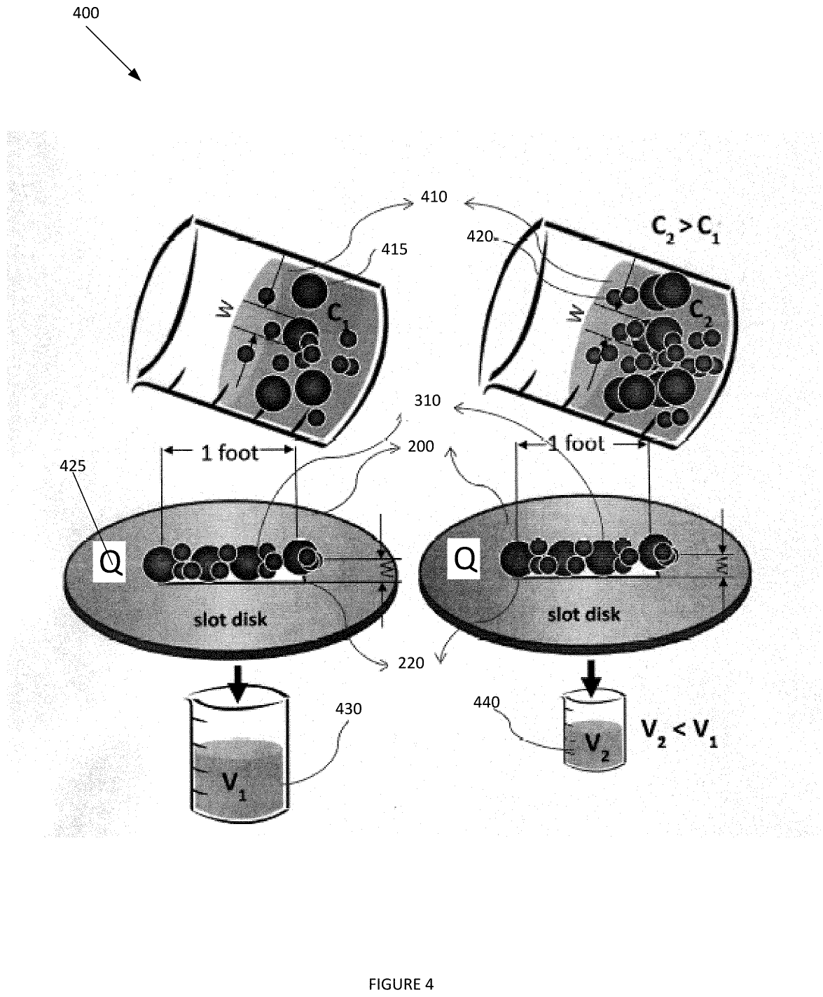

FIG. 4 depicts an embodiment 400 of determining a unit sealing slot quantity constant based on the concentration 415 or 420 of sealing particulates within a drilling fluid 410. As depicted in FIG. 4, concentration 415 may be lower than concentration 420. However, the same number of sealing particulates with the same weight 425 of seal 310 may be required to seal slot 220 within disk 200 though the two sealing fluids have two different concentrations of the sealing particulates. This may lead to the weight 425 of sealing slot 220 to be constant when using the same sealing composition of different concentrations 415, 420.

As such, for the same sealing composition, sealing a unit length of a slot 220 only requires a constant weight of sealing particulates within a given sealing fluid. This constant weight or unit sealing slot quantity constant 425 can be obtained through a slot disk test. Considering that all sealing particulates of seal 310 on a slot 220 were carried to the slot 220 by the spurt loss fluid that has flowed through the slot 220 during a slot disk test, the unit sealing slot quantity constant 425 of the sealing particulates on the slot 220 can be calculated by spurt loss volume 430 or 440 multiplied by the concentration 415 or 420 of the sealing particulates in the drilling fluid. Therefore, when utilizing the same sealing composition, a higher concentration 420 of sealing particulates may result in a lower spurt loss 440 than a spurt loss 430 associated with a lower concentration 415 of sealing particulates.

In other words, for a given concentration of a sealing composition in drilling fluid, with the spurt loss volume from a slot disk test, the unit sealing slot quantity constant of the seal can be obtained. Furthermore, conversely, when the unit sealing slot quantity constant is known for a sealing composition, if a desired spurt loss volume to be controlled is known, the necessary concentration of the sealing composition in drilling fluid can also be obtained. This desired spurt loss volume to be controlled comes directly from the unit fracture volume defined by the weak wellbore conditions.

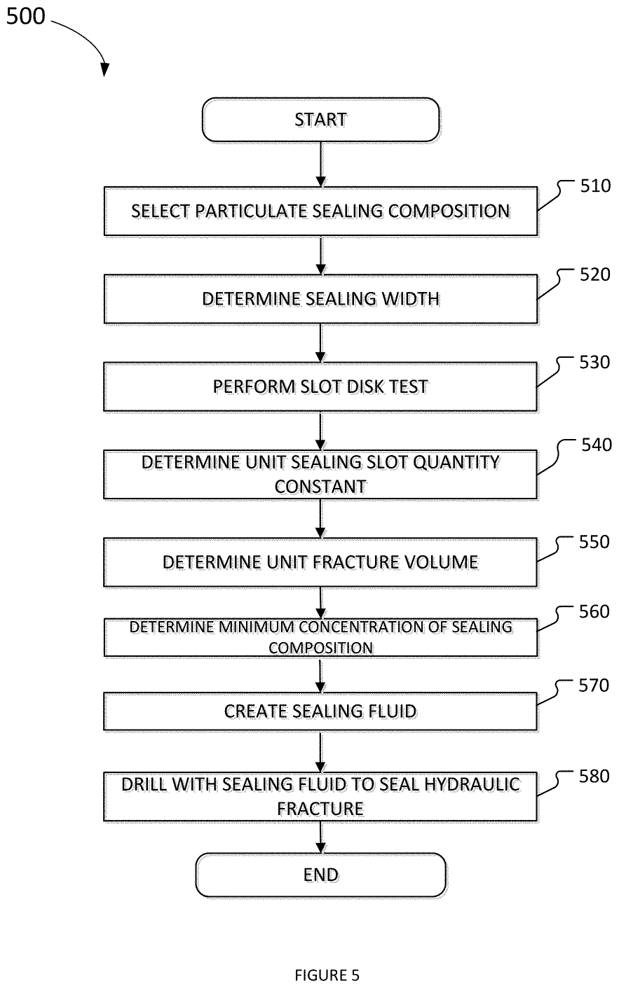

FIG. 5 depicts a method 500 for determining the minimum concentration of sealing particulates within drilling fluid to seal a hydraulic fracture, according to an embodiment. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

At operation 510, a particulate sealing composition with multiple sealing particulates may be selected. In embodiments, different sealing compositions may comprise various sealing particulates with different sealing efficiencies. However, for the same sealing composition, sealing a certain length of a slot requires only a certain quantity of the same sealing composition, no matter what the concentration of the sealing composition in the sealing fluid is. Therefore, for the same sealing composition, a high concentration may generate a low spurt loss, and a lower concentration may generate a higher spurt loss. As such, the quantity (Q) of sealing particulates of a known sealing composition required to seal the same slot will be equal whether there is a higher or lower concentration of sealing particulates within a sealing fluid.

At step 520, based on the particle size of the selected sealing composition, a sealing width within the sealing capacity of the sealing composition is selected and a slot disk with a slot width equal to the selected sealing width is also selected. The sealing width is typically slightly smaller than the size of the largest particulates in the sealing composition. A person having ordinary skill in the art knows how to select a sealing width.

At step 530, a spurt loss test may be performed with the selected slot disk. It is typical that, at a concentration, the sealing composition is mixed into drilling fluid to form a sealing fluid in order to conduct the test. Then the sealing fluid is let go through the slot disk in a test cell by applying pressure. The fluid collected from the other side of the slot disk when a seal to the slot has just formed is the spurt loss, which is the entire fluid that has just gone through the slot. The spurt loss volume is then measured. This spurt loss volume may be further converted to a unit spurt loss by dividing it with the total slot length.

At step 540, a unit sealing slot quantity constant of the known sealing composition may be determined. In embodiments, if a sealing composition in a sealing fluid has a known concentration Ci of sealing particulates in a sealing fluid and the slot has a given total length (L) and width (W), then a unit spurt loss Vi may be determined by the slot disk test in step 530. Then the weight of the sealing composition of the sealing particulates required to seal a unit length of the slot or the unit slot sealing quantity constant (Q) may be based on equation (1) below.

Q=C1V1 (1)

As discussed above, because Q is a constant, if a desired unit spurt loss is V₂, then the required concentration C₂ of the sealing composition in the sealing fluid should satisfy equation (2) below.

C1V1=C2V2=Q (2)

Different sealing compositions may have different unit sealing slot quantity constants. Even with similar particle size distributions, two different sealing compositions may have different unit sealing slot quantity constants at least partially due to different sealing material properties of the sealing particles in the compositions. Due to complexity of particulate sealing, this unit sealing slot quantity constant may be defined by a slot disk test.

At step 550, for drilling a weak wellbore, the unit hydraulic fracture volume (Vf) for the weak wellbore may be determined. With the given sealing width as W from the selected sealing composition or the slot disk test as the fracture width at the entrance, the unit hydraulic fracture volume Vf may be determined under a set of drilling parameters and formation properties (wellbore radius R, Young's Modulus YM, Poisson's Ratio PR, wellbore pressure P, formation horizontal stress S).

At step 560, Vf is also the maximum of unit spurt loss allowed into the fracture in order to form a seal at the entrance of a fracture. So with the known unit sealing slot quantity constant Q, the minimum concentration Cmin of the sealing composition in drilling fluid to control the spurt loss not exceeding Vf can be obtained by equation (3) below.

Cmin=Q/Vf (3)

At operation 570, a sealing fluid of sealing particulates and drilling fluid with a practical concentration of sealing particulates greater than Cmin may be created.

In operation 570, the drilling fluid for drilling the weak wellbore may be different from step 530, wherein a slot disk test is conducted to obtain the unit sealing slot quantity constant.

At operation 580, drilling with the sealing fluid, with the practical concentration of sealing particulates, into the wellbore may commence.

In applications for drilling, with the known unit sealing slot quantity constant Q, at a rig site, the concentration C of a sealing composition in drilling fluid can be monitored daily by testing unit spurt loss volume V. Then the concentration C can be calculated by using C=Q/V. Then, compare C with Cmin. When C is smaller than Cmin, more of the same sealing composition may be required to be added to the drilling fluid. When C is larger than Cmin, no more of the sealing composition may be required to be added to the drilling fluid. Furthermore, the difference between C and Cmin can determine how much more is needed.

For instance, in a first example, a hydraulic fracture and/or disk slot may have 1 foot as the unit length for either a fracture section height or a total slot length of a slot disk. A sealing composition may have a sealing width (W) of 850 microns based on the size of its largest particulates.

A single lab test with this composition of sealing particulates in drilling fluid at a concentration of C1 equals 20 pounds per barrel on a slot disk with a slot width of 850 microns and a total slot length of 1 foot may result in a unit spurt loss (V1) of 46 milliliters. Utilizing these known variables, step 530, 540 and equation (1) above can be solved. This would results in equation (1) equaling 20 pound/barrel*46 milliliter/foot=20 (pound×453.6 gram/pound)/(barrel×158987 milliliter/barrel)×46 milliliter/foot=2.62 gram/foot. As such, utilizing equation (1) above the unit sealing slot quantity constant (Q) of the known sealing composition may be 2.62 grams per foot. Because the unit sealing slot quantity constant (Q) is known now for the sealing composition, the minimum concentration of the sealing composition required for any level of the spurt loss control for a sealing fluid with the sealing composition can be defined. The level of spurt loss control is then defined by the unit fracture volume when its width equals W, the same as the slot width or the sealing width of the sealing composition selected.

For a first weak wellbore, with given rock mechanical properties and wellbore conditions, if the unit fracture volume is determined to be V=40 milliliter/foot, the minimum concentration Cmin of the composition in drilling fluid can be determined utilizing equation (3) above. Utilizing equation (3) the minimum concentration of the sealing composition in drilling fluid may be realized as: Q/V=2.62 gram/foot/40 milliliter/foot=2.62 (gram/453.6 gram×pound)/foot/40 (milliliter/158987 milliliter×barrel)/foot=23.0 pounds/barrel.

For a second weak wellbore, with given rock mechanical properties and wellbore conditions, if the unit fracture volume is determined to be V=60 milliliter/foot, the minimum concentration Cmin of the same sealing composition in drilling fluid can be determined utilizing equation (3) above. Utilizing equation (3) the minimum concentration of the sealing composition in drilling fluid may be realized as: Q/V=2.62 gram/foot/60 milliliter/foot=2.62 (gram/453.6 gram×pound)/foot/60 (milliliter/ 158987 milliliter×barrel)/foot =15.3 pounds/barrel.

After the minimum concentration is determined based on the unit fracture volume for a given fracture for a known sealing composition, the sealing composition may be added to drilling fluid at a concentration equal to or above the determined minimum concentration value. Then, an operator may drill the weak wellbore with the drilling fluid. Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system for determining a minimum concentration of a sealing composition of sealing particulates to drill a weak wellbore, the system comprising:
a slot disk with a slot, the slot having a slot width, wherein the slot width is equal to a sealing width of the sealing composition;
sealing particulates being configured to form a seal to seal the slot within the slot disk;
a first sealing fluid formed of drilling fluid and a first concentration of the sealing composition of the sealing particulates, wherein a unit sealing slot quantity constant for the sealing composition is determined with the first sealing fluid with the first concentration;
a second sealing fluid formed of a second drilling fluid and a second concentration of the sealing composition, wherein the second concentration is equal or greater than the minimum concentration.

2. The system of claim 1, wherein the unit sealing slot quantity constant is determined based on the weight of all the sealing particulates of the seal on the slot and a total slot length of the slot.

3. The system of claim 1, wherein the unit sealing slot quantity constant is based on a volume of spurt loss from a slot disk test.

4. The system of claim 1, wherein a unit fracture volume for the weak wellbore is determined based on the slot width or the sealing width.

5. The system of claim 1, wherein the minimum concentration of the sealing composition is determined based on the unit fracture volume and the unit sealing slot quantity constant.

6. The system of claim 1, wherein the sealing composition is mixed into drilling fluid at a second concentration equal to or greater than the minimum concentration.

7. The system of claim 1, wherein a particulate size of a largest particulate within the sealing particulates is larger than the slot width.

8. The system of claim 1, wherein the sealing particulates have different sizes.

9. The system of claim 1, wherein the first drilling fluid and the second drilling fluid are different drilling fluids.

10. The system of claim 1, wherein the first drilling fluid and the second drilling fluids are not different drilling fluids.

11. A method determining a minimum concentration of sealing particulates to drill a weak wellbore, method comprising:
forming a first sealing fluid that includes drilling fluid and a first concentration of the sealing particulates, the sealing particulates being configured to seal a slot within a slot disk, the slot having a slot width;
determining a unit sealing slot quantity constant for sealing the slot with the slot width by slot disk testing the slot utilizing the first sealing fluid with the first concentration;
determining the minimum concentration based on the determined unit sealing slot quantity constant;
forming a second sealing fluid that includes a second drilling fluid and a second concentration of the sealing particulates that is equal to or greater than the minimum concentration.

12. The method of claim 11, further comprising:
determining a unit fracture volume for the weak wellbore with the slot width as the fracture width at the entrance of the fracture.

13. The method of claim 12, further comprising:
determining the minimum concentration of the sealing particulates based on the unit sealing slot quantity constant and the unit fracture volume.

14. The method of claim 11, further comprising:
mixing the sealing particulates into drilling fluid at a second concentration equal to or greater than the minimum concentration.

15. The method of claim 11, further comprising:
determining a weight of all the sealing particulates to form the seal in the slot disk testing.

16. The method of claim 15, further comprising:
determining the unit sealing slot quantity constant based on the weight of all the sealing particulates forming the seal and a total slot length of the slot.

17. The method of claim 11, wherein the unit sealing slot quantity constant is based on a volume of spurt loss from the slot disk test.

18. The method of claim 11, wherein a particulate size of a largest particulate within the sealing particulates is larger than the slot width.

19. The method of claim 11, wherein the sealing particulates have different sizes.

20. The method of claim 11, wherein the first drilling fluid and the second drilling fluid are not different drilling fluids.
